(19) United States
(12) Patent Application Publication
(10) Pub. No.: US 2025/0130911 A1
(43) Pub. Date: Apr. 24, 2025

(54) HYBRID AGENT STRATEGY FOR FULL STACK OBSERVABILITY

(71) Applicant: Cisco Technology, Inc., San Jose, CA (US)

(72) Inventor: Walter Theodore Hulick, JR., Pearland, TX (US)

(21) Appl. No.: 18/415,892

(22) Filed: Jan. 18, 2024

Related U.S. Application Data
(60) Provisional application No. 63/545,318, filed on Oct. 23, 2023.

(51) Int. Cl. G06F 11/30

(52) U.S. Cl. CPC G06F 11/302

(57) ABSTRACT

In one implementation, a method is introduced herein that facilitates a hybrid agent strategy for full stack observability. The method can include observing, by a device executing an agent of a first observability platform, first observability information associated with the first observability platform and monitoring, by the device executing the agent, for a message containing second observability information on the device generated for a second observability platform. The method can further include generating a new observability information as a combination of the first observability information and the second observability information and providing the new observability information to a given observability backend service within a computer network via an observability pipeline associated with the given observability backend service.

### RELATED APPLICATION

This application claims priority to U.S. Prov. Appl. No. 63/545,318, filed Oct. 23, 2023, entitled HYBRID AGENT STRATEGY FOR FULL STACK OBSERVABILITY, by Hulick, Jr., the contents of which are incorporated herein by reference.

### TECHNICAL FIELD

The present disclosure relates generally to computer systems, and, more particularly, to a hybrid agent strategy for full stack observability.

### BACKGROUND

The field of software development has witnessed a significant shift with the advent of cloud-native environments and microservices architecture. Traditional monolithic applications are giving way to more agile and scalable cloud-based microservices. One such element in this transformation has been the Open Telemetry Java Agent (herein referred to as “OSS Java agent” or “OSS agent”).

Open Telemetry, in particular, is set to become the de-facto standard for Full Stack Observability (FSO). Because of this, there has been a lot of speculation and conversation about the role of agents in a Cloud Native environment since Open Telemetry will be used for tracing and monitoring in that environment, thus agents would essentially be obsolete. Moreover, the management infrastructure to manage monitoring tools would be designed and dictated by OpenTelemetry working groups.

Meanwhile, companies who already have performance and security products built for legacy applications use proprietary methods of instrumentation and reporting. This raises the question as to whether this new Cloud Native environment requires a completely new set of products that are all OpenTelemetry, or is it possible and feasible to find a strategy inside the application runtime that can be functional, if not beneficial, while also being perfectly compliant with the OpenTelemetry standard.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example code that may be used to create and end a span;

FIGS. 5-6 illustrate example simplified procedures for a hybrid agent strategy for full stack observability, in accordance with one or more implementations described herein;

FIG. 7 illustrates a simplified example hybrid agent environment according to the techniques herein; and

FIG. 8 illustrates an example simplified procedure for a hybrid agent strategy for full stack observability in accordance with one or more implementations described herein.

### DESCRIPTION OF EXAMPLE EMBODIMENTS

### Overview

According to one or more implementations of the disclosure, a method is introduced herein that facilitates a hybrid agent strategy for full stack observability. The method can include observing, by a device executing an agent of a first observability platform, first observability information associated with the first observability platform and monitoring, by the device executing the agent, for a message containing second observability information on the device generated for a second observability platform. The method can further include generating a new observability information as a combination of the first observability information and the second observability information and providing the new observability information to a given observability backend service within a computer network via an observability pipeline associated with the given observability backend service.

The techniques herein greatly expand the ability to pull correlation information from OTEL on the fly (e.g., trace/span id) and inject non-OTEL related information into the existing OTEL pipeline to enhance the OTEL backend experience. For instance, the techniques herein add value to the OTEL backend system by providing additional events, metrics, snapshots, etc. to the OTEL backend system, while also, and optionally at the same time, adding value to the legacy backend systems by providing OTEL correlation information and other observability aspects to the legacy backend system.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

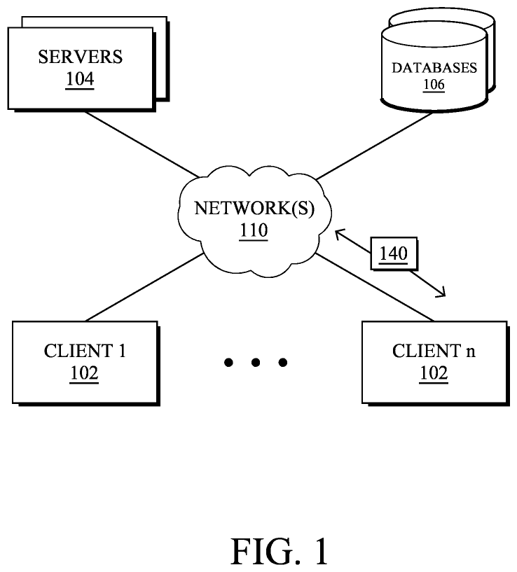

FIG. 1 is a schematic block diagram of an example simplified computing system 100 illustratively comprising any number of the client devices 102 (e.g., a first through nth client device), one or more of servers 104, and one or more of databases 106, where the devices may be in communication with one another via any number of networks (e.g., networks 110). The one or more networks (e.g., networks 110) may include, as would be appreciated, any number of specialized networking devices such as routers, switches, access points, etc., interconnected via wired and/or wireless connections. For example, devices 102-104 and/or the intermediary devices in network(s) (e.g., networks 110) may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) (e.g., networks 110).

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in simplified computing system 100, and that the view shown herein is for simplicity. Also, those skilled in the art will further understand that while the network is shown in a certain orientation, the simplified computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

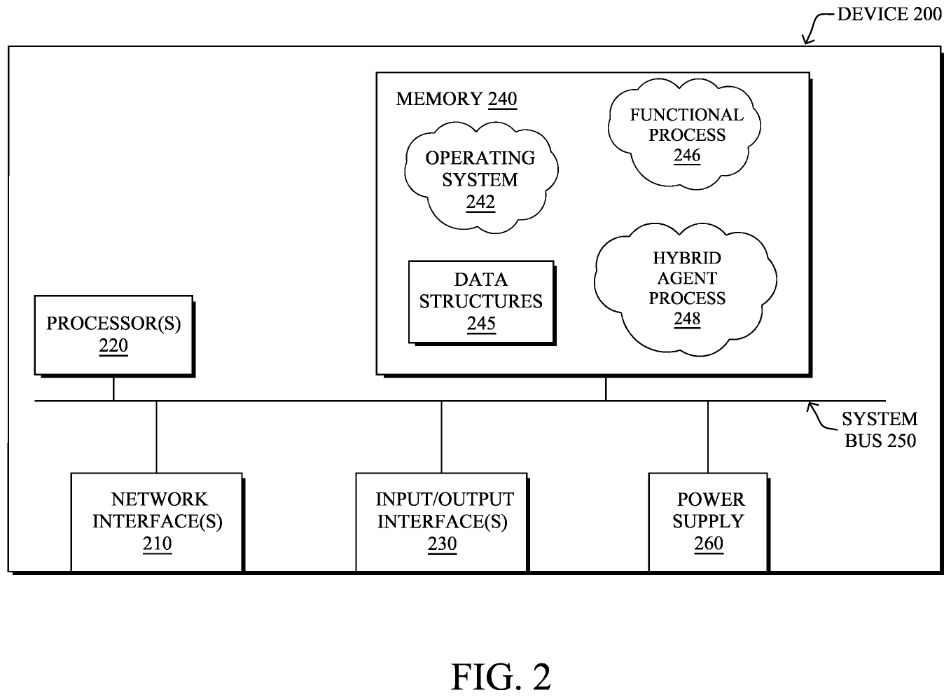

FIG. 2 is a schematic block diagram of an example node/device 200 (e.g., apparatus) that may be utilized with one or more implementations described herein, e.g., as any of the devices 102-106 shown in FIG. 1 described above as well as the present disclosure described below. Device 200 may comprise one or more network interfaces (e.g., network interfaces 210) (e.g., wired, wireless, etc.), at least one processor (e.g., processor 220), and a memory 240 interconnected by a system bus 250, as well as a power supply 260 (e.g., battery, plug-in, etc.).

The network interface(s) (e.g., network interfaces 210) contain the mechanical, electrical, and signaling circuitry for communicating data over links coupled to the network(s) (e.g., networks 110). The network interfaces may be configured to transmit and/or receive data using a variety of different communication protocols. Note, further, that device 200 may have multiple types of network connections via network interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise one or more of functional processes 246, and on certain devices, a hybrid agent process 248, as described herein. Notably, functional processes 246, when executed by processor(s) (e.g., processor 220), cause each particular device (e.g., device 200) to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

### —Observability Intelligence Platform—

Distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more implementations herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

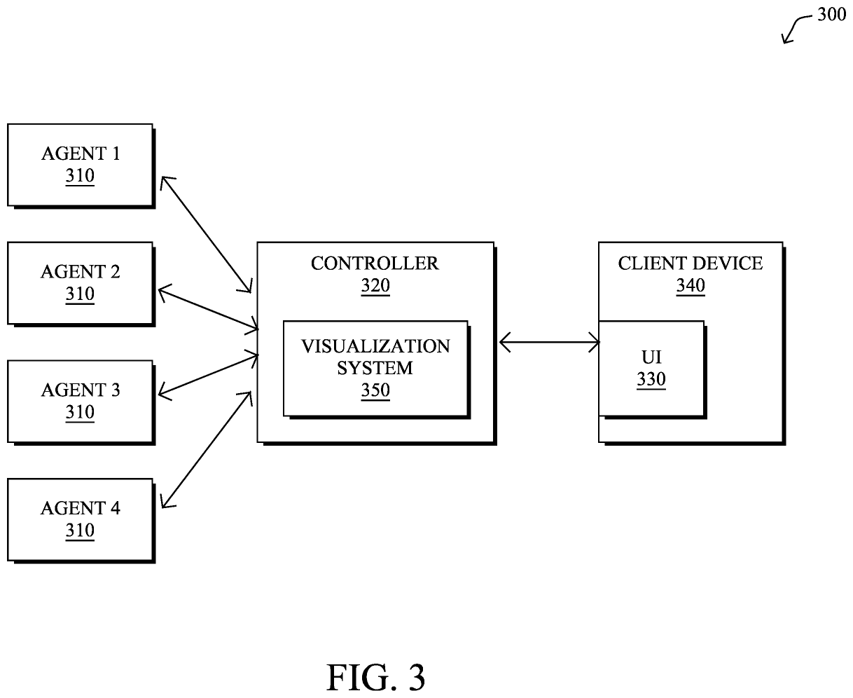

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable implementation of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more of agents 310 and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller(s) (e.g., controller 320) as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) (e.g., interface 330) that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, a controller instance (e.g., controller 320) may be hosted remotely by a provider of the observability intelligence platform 300. In an illustrative on-premises (On-Prem) implementation, a controller instance (e.g., controller 320) may be installed locally and self-administered.

Controllers 320 receive data from different agents (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one implementation, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain implementations, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

### —Hybrid Agent Strategy for Full Stack Observability—

As noted above, Open Telemetry is set to become the de-facto standard for Full Stack Observability (FSO), leaving questions regarding the future of agents in a Cloud Native environment. This is especially true for companies who already have proprietary performance and security products for instrumentation and reporting. The question addressed herein is whether this new Cloud Native environment requires a completely new set of products that are all OpenTelemetry, or is it possible and feasible to find a strategy inside the application runtime that can be functional, if not beneficial, while also being perfectly compliant with the OpenTelemetry (or “OTEL”) standard.

For an application, there are conventionally several types of potential instrumentation:
A hand-written tracer/capture developed using an available software development kit (SDK);
An Open Telemetry Java Agent (herein referred to as an “OSS Java agent” or “OSS agent”), which may be an opensource software (OSS) java agent developed within the OpenTelemetry community to provide automatic instrumentation with its own tracer/capture; or
Third-party libraries that include hand-written tracer/capture API/SDK.

Notably, it's possible to have one or more of these instrumentation techniques operating in a runtime—all instrumenting different things—different versions of the API/SDK and all reporting to different receivers (locations)—which is quite complicated.

The techniques herein, therefore, describe mechanisms that facilitate a hybrid agent strategy for full stack observability, greatly expanding the ability to pull correlation information from OTEL on the fly (e.g., trace/span id) and inject non-OTEL related information into the existing OTEL pipeline to enhance the OTEL backend experience. That is, the techniques herein allow for pulling the info (trace/span ids) from one or more of the different instrumentation techniques above in real time, and also allow for sending the information to a non-OTEL location for correlation. Moreover, the techniques herein allow for the insertion of metadata or enhanced FSO information to send to one or more OTEL receivers for enhanced correlation/context. Said differently, the techniques herein add value to the OTEL backend system by providing additional events, metrics, snapshots, etc. to the OTEL backend system, while also, and optionally at the same time, adding value to the legacy backend systems (cloud-based software as a service or “CSaaS”, etc.) by providing OTEL correlation information and other observability aspects to the legacy backend system. Notably, the techniques herein can work across multiple FSO tools and opens the doors to collaboration between OTEL and other tools—also providing a bridging technology to buy time in the OTEL migration.

Illustratively, the techniques described herein may be performed by hardware, software, and/or firmware, such as in accordance with hybrid agent process 248, which may include computer executable instructions executed by the processor 220 (or independent processor of network interfaces 210) to perform functions relating to the techniques described herein.

As a primer, the OTEL API is simply an interface—it defines the Classes and Method interfaces that defines the capability. The OTEL SDK is simply an out-of-band (OOB) implementation for the interface for convenience—it must subscribe 100% to the OTEL API. Any third party vendor can extend the SDK and/or implement the API as long as they do not alter the underlying functionality outside of the OTEL specifications.

A typical OTEL runtime can be a mix of both manually instrumented SDK/APIs or in the case of the OTEL Java Agent—it contains an API/SDK which is “automatically” injected into the Runtime using instrumentation. In most cases—the focus is on the “trace” API (part of the overall API). If one can access these Tracers and get the actual OTEL APIs and intercept them while still adhering to the standard—there are many possibilities afforded by such a system, as described herein.

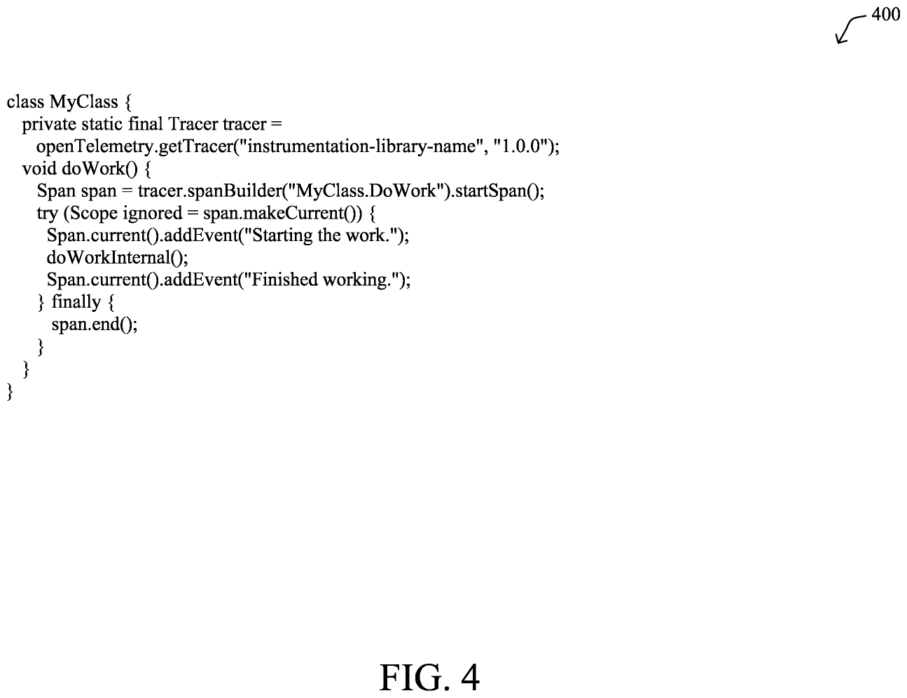

According to certain implementations herein, FIG. 4 illustrates an example code 400 that may be used to create and end a span, which may be found within an application, accordingly, to create a Tracer, create and start a Span, makes that the current Span, add a Start Event to the Span, and adds an End Event to the Span. Namely:

```
class MyClass {
  private static final Tracer tracer =
    openTelemetry.getTracer(“instrumentation-library-name”, “1.0.0”);
  void doWork( ) {
    Span span = tracer.spanBuilder(“MyClass.DoWork”).startSpan( );
    try (Scope ignored = span.makeCurrent( )) {
      Span.current( ).addEvent(“Starting the work.”);
      doWorkInternal( );
      Span.current( ).addEvent(“Finished working.”);
    } finally {
      span.end( );
    }
  }
}
```

Specifically, according to one or more embodiments described herein, a method can include observing, by a device executing an agent of a first observability platform, first observability information associated with the first observability platform and monitoring, by the device executing the agent, for a message containing second observability information on the device generated for a second observability platform. The method can further include generating a new observability information as a combination of the first observability information and the second observability information and providing the new observability information to a given observability backend service within a computer network via an observability pipeline associated with the given observability backend service.

Operationally and according to various implementations, the techniques herein provide a “hybrid” Agent that is capable of pulling information from OTEL to insert into events, metrics, etc., which would be sent to the legacy backend system—and that is capable of pushing “extension” events, metrics, etc. into the OTEL pipeline to eventually be consumed by an OTEL backend over the OpenTelemetry Protocol (OTLP).

This strategy can be applied to any type of product—whether it be performance or security, the hybrid model herein would work, allowing for the use of products and services that are already built.

Notably, the term “Hybrid” herein implies that the Agent is capable of providing value to two different platforms at the same time:
For existing Proprietary Commercial SaaS:
   An existing management system on the CSaaS side;
   Provides events, etc. to the existing management system same as it would for a non OTEL environment;
   No changes to the existing product management system; and
   Enhances the current offering with OTEL trace id and span id information for events.
For OTEL Traces and Spans sent to backend OTEL receivers:
   Adds Events;
   Adds Exceptions;
   Provides Span Context (Security Risk, etc.); and
   Adds relevant key/value attributes.

To implement the hybrid strategy, the techniques herein must illustratively be capable of instrumenting and “tapping into” the existing OTEL pipeline. This would allow discovering Tracers and gaining access to the Span Context at any point in time, allowing to either extract information or add information from/to the OTEL pipeline. This strategy enriches existing products with OTEL correlation and enriches the OTEL backend systems by providing “value add” extensions to the runtime instrumentation that would be completely OTEL compliant.

There are two key components to the hybrid agent strategy described herein. First, the techniques herein track Span creation to map them to a Thread, and then make that accessible. In particular, the use of bytecode instrumentation, which is essentially used for interception of method entry/method exit, traditionally had access to a Thread's Current Span regardless of what OTEL implementation it was using. In this case, the interception will take place in the OTEL instrumentation in a Java Agent or Agent loaded component.

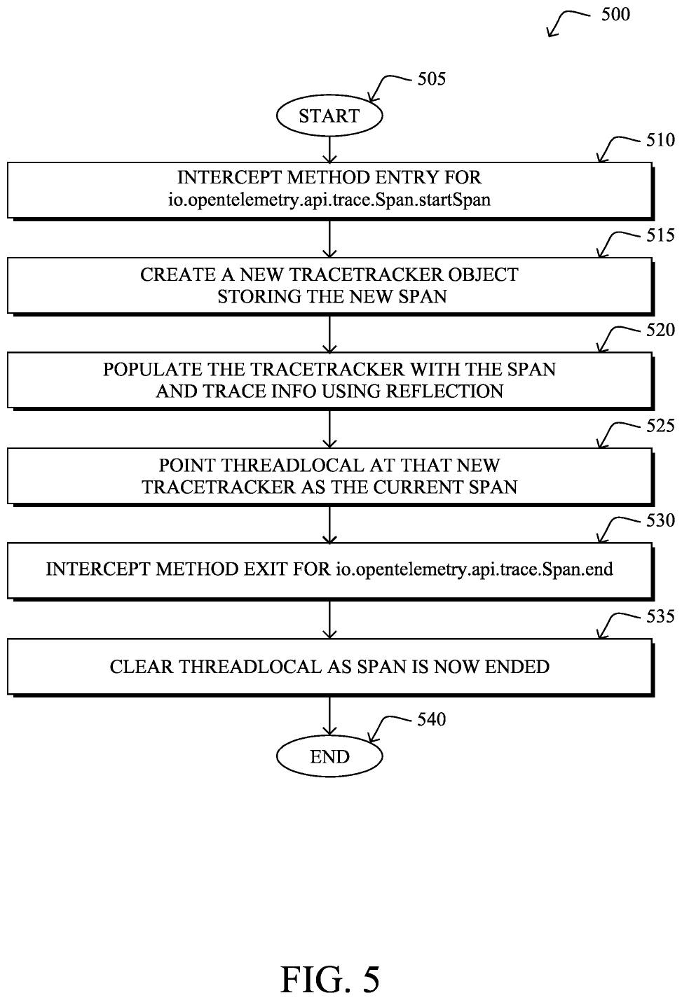

As shown in the process 500 of FIG. 5, the Agent Interception code will do the following procedure, starting with step 505, to always track the current Span in the context of the Thread:
Step 510: Intercept method entry for io.opentelemetry.api.trace.Span.startSpan;
Step 515: Create a new TraceTracker object storing the new Span;
Step 520: Populate the TraceTracker with the Span and Trace info using Reflection so it does not have to be completed in realtime impacting the Application (using reflection as direct calls to OTEL would cause ClassLoading issues)—the majority of what is used is in the SpanContext;
Step 525: Point ThreadLocal at that new TraceTracker as the current Span;
Step 530: Intercept method exit for io.opentelemetry.api.trace.Span.end; and
Step 535: Clear ThreadLocal as Span is now ended.
   The process 500 then ends in step 540.

The second key component herein is that when the Event occurs, the techniques herein access the current Span Info to pull from OTEL or inject into the OTEL pipeline stream. In this case, the techniques herein look up the TraceTracker object stored in the ThreadLocal location—providing access to the information in the TraceTracker object—and also to the Span.

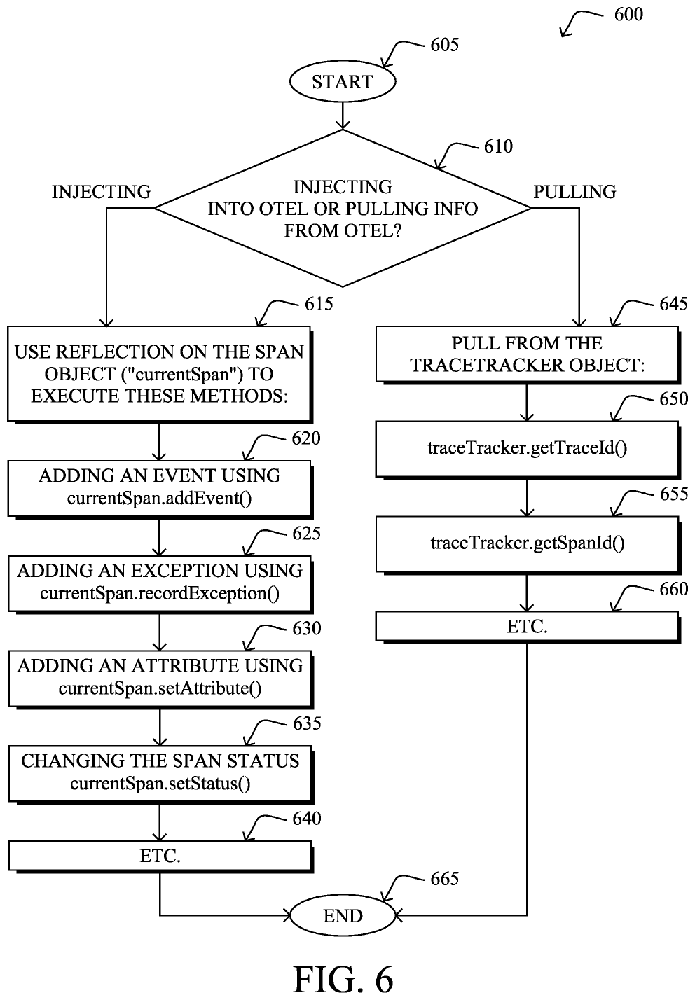

As shown in the process 600 of FIG. 6, which starts with step 605, the techniques herein determine whether it is injecting into OTEL or pulling info from OTEL in step 610. In the case of injecting into OTEL, the techniques herein would use reflection in step 615 on the Span Object (herein referred to as “currentSpan”) to execute these methods:
Method 620: Adding an Event Using currentSpan.addEvent( );
Method 625: Adding an exception using currentSpan.recordException( );
Method 630: Adding an attribute using currentSpan.setAttribute( );
Method 635: Changing the Span Status currentSpan.setStatus( );
Method 640: Etc.

In the case of pulling info from OTEL in step 610, to send to a proprietary CSaaS system, the techniques herein would just pull from the TraceTracker object in step 645 to obtain:
Info 650: traceTracker.getTraceId( );
Info 655: traceTracker.getSpanId( );
Info 660: Etc.
   The process 600 then ends in step 665.

FIGS. 5-6 thus collectively illustrate example simplified procedures for a hybrid agent strategy for full stack observability, in accordance with one or more implementations described herein. For example, a non-generic, specifically configured device (e.g., device 200) may perform procedures 500-600 by executing stored instructions (e.g., hybrid agent process 248). It should be noted that while certain steps within procedures 500-600 may be optional as described above, the steps as shown in FIGS. 5-6 are merely examples for illustration, and certain other steps may be included or excluded as desired. Further, while a particular order of the steps is shown, this ordering is merely illustrative, and any suitable arrangement of the steps may be utilized without departing from the scope of the implementations herein. Moreover, while procedures may be described separately, certain steps from each procedure may be incorporated into each other procedure, and the procedures are not meant to be mutually exclusive.

The techniques described herein, therefore, facilitate a hybrid agent strategy for full stack observability. By instrumenting OTEL APIs, the techniques herein allow for: Finding all the active Tracers (there can be multiple tracers servicing both manual and automatic instrumentation); Locating the OTEL versions; Determining the current Span and Trace ID for the current transaction (from the Span Context); Adding additional information such as Application Correlation, Events, etc. to the existing OTEL pipeline (piggyback); Managing the OTEL framework inside the runtime; and so on. Essentially, the techniques herein can provide the possibility of some interesting scenarios to enhance the OTEL experience and to build bridges between OTEL and other systems—all of this using the APIs and SDKs that are already in the runtime.

Notably, Open Telemetry opens a lot of doors to perform correlation using the Trace/Span ID designed to build flow maps. However, it also opens doors to “tag” and correlate eventing with other products and systems by attaching this correlation to proprietary events and logs. In addition, Open Telemetry is very “performance centric” in terms of the kind of MELT (Metrics, Events, Logs, and Trace) data collected—however, it's not architected in a manner that it cannot support other types of data collected such as Security, Reliability, and even Power related: it's simply not used that way. An instrumentation system capable of tapping into existing OTEL implementations and pulling correlation/injecting new data sources is thus extremely valuable. In one implementation, for example, a security product may be designed to correlate trace/span ids into security events, while simultaneously injecting security context into OTEL Spans (and this may be done with any OTEL implementation).

Such a “Security Hybrid Agent” in the OTEL environment (e.g., based on a security app/product such as Cisco Secure Application (CSA) available from Cisco Systems, Inc.) would be a complement to the existing observability platform described above. For instance, observability intelligence platform above is a great example of an “agent system” that already provides value for traditional application frameworks and eco-systems, and is a natural “add on” to Cloud Native applications that are instrumented with OTEL.

Today, many security apps run bundled with legacy observability agents and report to a backend SaaS system (e.g., a security app Controller). The security app agent registers and heartbeats every minute to get updates to its configuration (e.g., a new policy). The security app Agent identifies itself via Node, Tier, and Application (similar to observability platforms) to the security app controller. The security app controller uses that information to communicate with the observability controller to verify licensing/onboarding. The security app sends vulnerability reports, security events, and runtime information to the security app controller as part of its Application Security feature set.

Cloud Native applications suffer from the same vulnerabilities and exploits as traditional application runtimes—they are not immune to security exploits. This opens up an entirely new market for a “light weight” Application Security product to operate side-by-side with OTEL instrumented applications. The idea of enhancing OTEL monitoring with Security Events which provide correlation to OTEL traces and spans would be revolutionary in the marketplace. However, the question has been whether this system could be built without major refactoring of the security app agent and the security app controller. The techniques herein thus solve that question with a Security Hybrid Agent architecture.

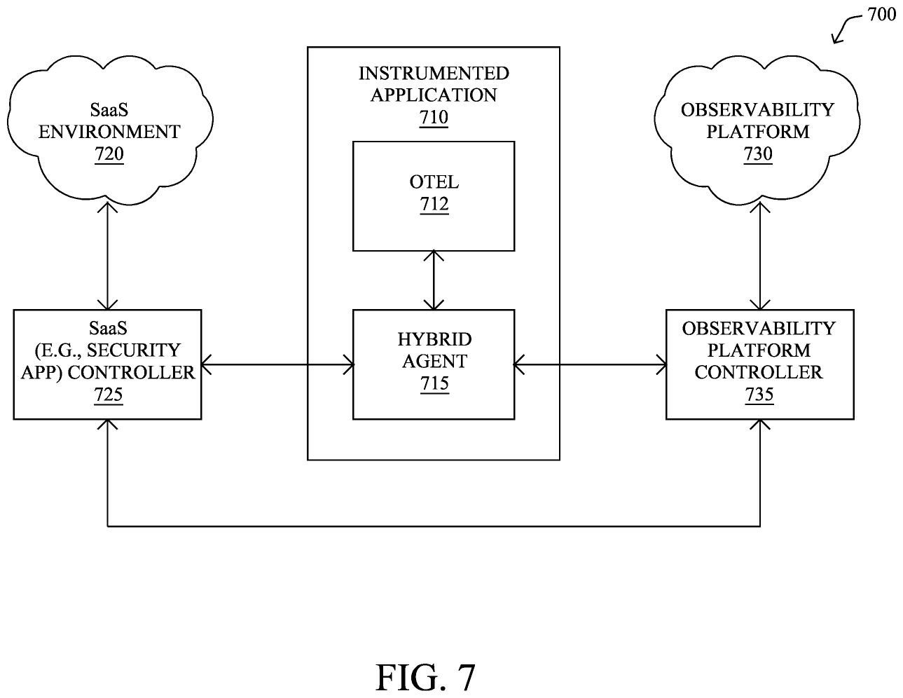

FIG. 7 illustrates a simplified example Hybrid Agent environment 700 according to the techniques herein, and that may be used to visualize the Security Hybrid Agent architecture mentioned above. For instance, an instrumented application 710 may establish OTEL information 712, and is instrumented by a hybrid agent 715 as described herein. The hybrid agent communicates with both a SaaS environment 720 via a corresponding SaaS (e.g., Security App) controller 725, as well as with an observability platform 730 via an observability platform controller 735, accordingly.

In certain implementations herein, to effectuate such a hybrid architecture, the Cloud Native eco-system (e.g., Kubernetes pods and services with an Ingress Controller) should (e.g., must) provide an outbound path to the SaaS environment (to the management system). The Hybrid Agent should (e.g., must) be configured with the same identification credentials as that of the existing SaaS system (in the case of security app it would “mimic” the observability platform Legacy Agent registration since the observability platform Legacy Agent will not be present). The Hybrid Agent would be light (e.g., run in less than 6 mb) and be capable of quick startup, registration, etc. and “container aware”—(in the case of security app this could be a Multi-Tenant Agent).

There may also be some minor “adjustments” to the SaaS Controller (in the case of security app—to use the security app Controller with no changes required—one implementation would “stand up” a dummy observability Controller that would do nothing but service the registration requests and provide services—such as licensing and onboarding to the security app controller). Also, one deployment option could be as simple as pulling the Hybrid Agent into the Docker Image when the Image is built.

According to the techniques herein, for this architecture to work, the Hybrid Agent is able to instrument and intercept the OTEL tracing pipeline. Moreover, for guaranteed delivery of Security Events to the OTEL backend, the Hybrid Agent would also have to be able to control sampling—Spans sampled out containing Security events and exceptions would prohibit their delivery.

Regarding Hybrid Agent instrumentation to service CSaaS via OTEL pipeline information extraction and adding to Web Services, when a Security Event occurs (e.g., Remove Command Execution, etc.)—the techniques herein may obtain the current Span object. Notably, to get the current Span object—the system herein would need access to the exact Span Class used in the Application to then call Span currentSpan=Span.current( ). To get the trace id and span id—the techniques herein would do byte[ ] traceId=currentSpan.getSpanContext( ).getTraceIdBytes( ) and byte[ ] spanId=currentSpan.getSpanContext( ).getSpanIdBytes( ), respectively.

In addition, at this point the system herein could also access existing attributes, events, baggage, etc. information (e.g., using reflection or other techniques). Now, the Security Event would then be sent to CSaaS (security app Controller) similar to how this occurs in a non-OTEL environment—however in this case, OTEL trace id, span id, metadata, etc. would be stored as part of the security event.

Regarding Hybrid Agent instrumentation to service via OTEL pipeline information injection using API/SDK via OTLP, when a Security Event occurs (e.g., Remove Command Execution, etc.), the system herein needs the current Span object, and to get the current Span object, accesses the exact Span Class used in the Application to then call Span currentSpan=Span.current( ). Once the currentSpan is obtained, the techniques herein now check to ensure it's not sampled out (currentSpan.isSampled( )), and if not, the system herein has the option of:
Adding an event using currentSpan.addEvent( );
Adding an exception using currentSpan.recordException( );
Adding an attribute using currentSpan.setAttribute( ); or
Changing the Span Status currentSpan.setStatus( ).

From this point forward—the additional information is in the OTEL Pipeline and will be propagated to the backend.

Note that if that backend is an observability platform Cloud, then it should dispatch any security app information to a “processing plugin” based on identifying “tags” so that the observability platform can do additional processing.

There are several methods to get the Current Spans for a Thread:
Reflection into OTEL's Thread Local Storage inside the OTEL SDK; or
Intercepting of Span.makeCurrent( ) which specifies current span—placing the intercepted object as a Span into a ThreadLocal Array—on Span.end( ) simply remove from ThreadLocal.

However, the idea of using Context.current( ) or Span.current( ) would likely only work if they are capable of going to a global area that would be independent of the ClassLoader Context of the Span class as to use the Span class directly in the instrumentation would be risky as boot classes are instrumented and one would have to put the API and SDK libraries into the boot loader which would cause problems where this version of OTEL would be delegated to versus application level loaders. Note that it would work should there be a single version of the API and SDK libraries be used application wide—but this itself would not be feasible.

Accordingly, based on the Hybrid Agent Instrumentation concept herein, Agents are designed to be “Hybrid”, meaning that out-of-band operation can occur in the following manner:
Servicing SaaS and traditional eco-system via proprietary methods (REST, etc.);
Servicing OTEL backends and cloud native system (e.g., including observability platforms into this) via OTLP (OTEL Transport) of Traces/etc.; and
Servicing both at the same time if required.

As described in greater detail above, this may be accomplished by “tapping into” the OTEL pipeline system and using whatever Tracers, collectors, etc. are there—the agents should be “OTEL aware”—having the ability to locate a current Span and Trace in real time. This concept can be applied to any product technology—to enrich both the OTEL backend information with extensions and the existing SaaS backend information with correlation ids that can be stored and used to do a “launch in context” launch into a UI with the associated trace.

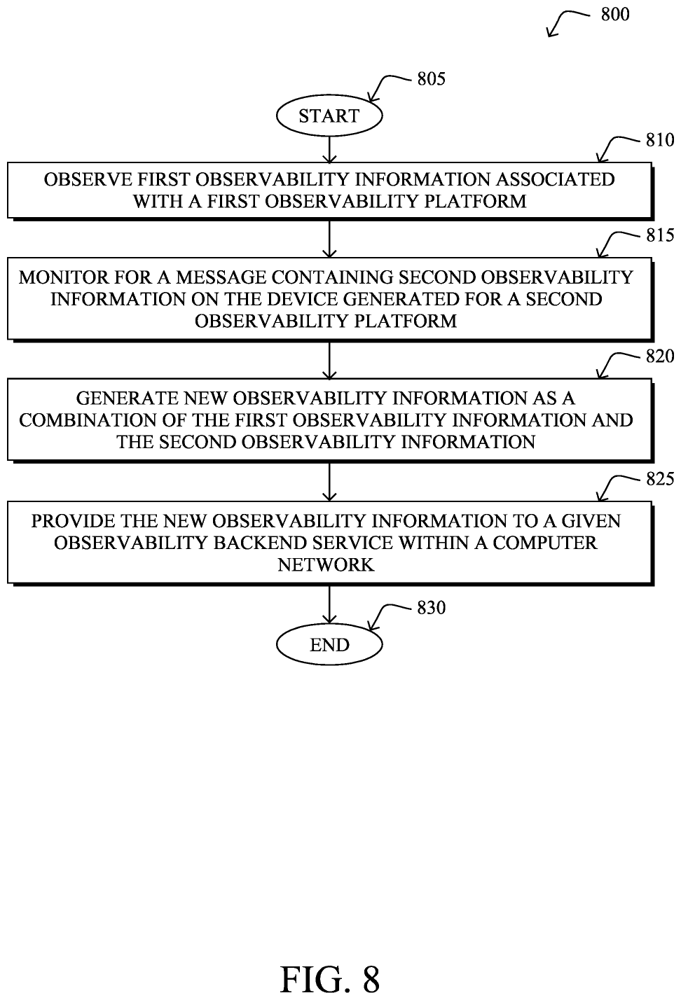

FIG. 8 illustrates an example simplified procedure for a hybrid agent strategy for full stack observability in accordance with one or more implementations described herein. For example, a non-generic, specifically configured device (e.g., device 200) may perform procedure 800 by executing stored instructions (e.g., the hybrid agent process 248). The procedure 800 may start at step 805, and continues to step 810, where, as described in greater detail above, a device executing an agent of a first observability platform observes first observability information associated with the first observability platform. In some implementations, the first observability information can comprise observability information selected from a list consisting of: security information, reliability information, and power information.

The procedure continues to step 815 where, as described in greater detail above, the device executing the agent monitors for a message containing second observability information on the device generated for a second observability platform. In some implementations, the second observability information can comprise performance-based observability information. In addition to, or in the alternative, the monitoring can comprise instrumenting, by the agent, an application programming interface associated with the second observability platform on the device. In such implementations, instrumenting the application programming interface can be configured to intercept the message as a method entry for a start of a new telemetry span.

The procedure continues to step 820 where, as described in greater detail above, new observability information is generated as a combination of the first observability information and the second observability information. As discussed above, the first observability information or the second observability information, or both, can comprise information selected from a list consisting of: metrics, events, logs, and traces.

The procedure continues to step 825 where, as described in greater detail above, the new observability information is provided to a given observability backend service within a computer network via an observability pipeline associated with the given observability backend service. In some implementations, the given observability backend service can be associated with the first observability platform, and the second observability information is added to the observability pipeline associated with the first observability platform. In addition to, or in the alternative, in some implementations, the given observability backend service can be associated with the second observability platform, and the first observability information is added to the observability pipeline associated with the second observability platform. As discussed herein, the given observability backend service can execute a cyber security as a service application, although implementations are not so limited.

As discussed herein, the monitoring, accessing, and generating steps discussed above can occur during runtime of a particular application executing on the device.

In some implementations, the procedure 800 can include adding, as part of generating the new observability information, at least one of an event, an exception, a context, or an attribute from the first observability information to the second observability information to generate the new observability information. In addition to, or in the alternative, the procedure 800 can include adding, as part of generating the new observability information, at least one of an event, a telemetry trace identifier, or a telemetry span identifier from the second observability information to the first observability information to generate the new observability information. As discussed above, the procedure 800 can include setting a status within the new observability information to indicate a presence of the new observability information.

In some implementations, the message can be a new telemetry span associated with an application thread and the procedure 800 can further include creating a new object that temporarily stores the new telemetry span, pointing to the new object as a current telemetry span within the application thread, and manipulating the new object, and therefore the current telemetry span, as part of generating the new observability information.

The procedure 800 may then end in step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

In some implementations, an apparatus comprising one or more network interfaces to communicate with a network, a processor coupled to the one or more network interfaces and configured to execute one or more processes, and a memory configured to store a process that is executable by the processor. In such implementations, the process, when executed, may be configured to observe, by a device executing an agent of a first observability platform, first observability information associated with the first observability platform, monitor, by the device executing the agent, for a message containing second observability information on the device generated for a second observability platform, generate a new observability information as a combination of the first observability information and the second observability information, and provide the new observability information to a given observability backend service within a computer network via an observability pipeline associated with the given observability backend service.

In still other implementations, a tangible, non-transitory, computer-readable medium can have computer-executable instructions stored thereon that, when executed by a processor on a computer, cause the computer to perform a method comprising observing, by a device executing an agent of a first observability platform, first observability information associated with the first observability platform, monitoring, by the device executing the agent, for a message containing second observability information on the device generated for a second observability platform, generating a new observability information as a combination of the first observability information and the second observability information, and providing the new observability information to a given observability backend service within a computer network via an observability pipeline associated with the given observability backend service.

The techniques described herein, therefore, provide for a “hybrid” Agent that is capable of pulling information from OTEL to insert into events, metrics, etc., which would be sent to the legacy backend system—and that is capable of pushing “extension” events, metrics, etc. into the OTEL pipeline to eventually be consumed by an OTEL backend over the OpenTelemetry Protocol (OTLP).

Illustratively, the techniques described herein may be performed by hardware, software, and/or firmware, such as in accordance with the hybrid agent process 248, which may include computer executable instructions executed by the processor 220 to perform functions relating to the techniques described herein, e.g., in conjunction with corresponding processes of other devices in the computer network as described herein (e.g., on network agents, controllers, computing devices, servers, etc.). In addition, the components herein may be implemented on a singular device or in a distributed manner, in which case the combination of executing devices can be viewed as their own singular “device” for purposes of executing the hybrid agent process 248.

While there have been shown and described illustrative implementations herein that facilitate a hybrid agent strategy for full stack observability, it is to be understood that various other adaptations and modifications may be made within the spirit and scope of the implementations herein. For example, while certain implementations herein are described herein with respect to using the techniques herein for certain purposes, the techniques herein may be applicable to any number of other use cases, as well. In addition, while certain protocols are discussed herein, particularly OpenTelemetry, the techniques herein may be used in conjunction with any similar protocols.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
observing, by a device executing an agent of a first observability platform, first observability information associated with the first observability platform;
monitoring, by the device executing the agent, for a message containing second observability information on the device generated for a second observability platform;
generating a new observability information as a combination of the first observability information and the second observability information; and
a providing the new observability information to a given observability backend service within a computer network via an observability pipeline associated with the given observability backend service.

2. The method as in claim 1, wherein the given observability backend service is associated with the first observability platform, and the second observability information is added to the observability pipeline associated with the first observability platform.

3. The method as in claim 1, wherein the given observability backend service is associated with the second observability platform, and the first observability information is added to the observability pipeline associated with the second observability platform.

4. The method as in claim 1, wherein the first observability information or the second observability information, or both, comprise information selected from a list consisting of: metrics, events, logs, and traces.

5. The method as in claim 1, wherein the second observability information comprises performance-based observability information.

6. The method as in claim 1, wherein the first observability information comprises observability information selected from a list consisting of: security information, reliability information, and power information.

7. The method as in claim 1, further comprising:
adding, as part of generating the new observability information, at least one of an event, an exception, a context, or an attribute from the first observability information to the second observability information to generate the new observability information.

8. The method as in claim 1, further comprising:
adding, as part of generating the new observability information, at least one of an event, a telemetry trace identifier, or a telemetry span identifier from the second observability information to the first observability information to generate the new observability information.

9. The method as in claim 1, further comprising:
setting a status within the new observability information to indicate a presence of the new observability information.

10. The method as in claim 1, wherein the given observability backend service executes a cyber security as a service application.

11. The method as in claim 1, wherein monitoring, accessing, and generating occur during runtime of a particular application executing on the device.

12. The method as in claim 1, wherein monitoring comprises instrumenting, by the agent, an application programming interface associated with the second observability platform on the device.

13. The method as in claim 12, wherein instrumenting the application programming interface is configured to intercept the message as a method entry for a start of a new telemetry span.

14. The method as in claim 1, wherein the message is a new telemetry span associated with an application thread, the method further comprising:
creating a new object that temporarily stores the new telemetry span; and
pointing to the new object as a current telemetry span within the application thread; and
manipulating the new object, and therefore the current telemetry span, as part of generating the new observability information.

15. The method as in claim 1, wherein the second observability platform comprises an OpenTelemetry platform.

16. An apparatus, comprising:
one or more network interfaces to communicate with a network;
a processor coupled to the one or more network interfaces and configured to execute one or more processes; and
a memory configured to store a process that is executable by the processor, the process, when executed, configured to:
observe, as a device executing an agent of a first observability platform, first observability information associated with the first observability platform;
monitor, by the device executing the agent, for a message containing second observability information on the device generated for a second observability platform;
generate a new observability information as a combination of the first observability information and the second observability information; and
provide the new observability information to a given observability backend service within a computer network via an observability pipeline associated with the given observability backend service.

17. The apparatus as in claim 16, wherein the given observability backend service is associated with the first observability platform, and the second observability information is added to the observability pipeline associated with the first observability platform.

18. The apparatus as in claim 16, wherein the given observability backend service is associated with the second observability platform, and the first observability information is added to the observability pipeline associated with the second observability platform.

19. The apparatus as in claim 16, wherein the process, when executed, is further configured to:
add, as part of generating the new observability information, at least one of an event, an exception, a context, or an attribute from the first observability information to the second observability information to generate the new observability information, or
add, as part of generating the new observability information, at least one of an event, a telemetry trace identifier, or a telemetry span identifier from the second observability information to the first observability information to generate the new observability information.

20. A tangible, non-transitory, computer-readable medium having computer-executable instructions stored thereon that, when executed by a processor on a computer, cause the computer to perform a method comprising:
observing, as a device executing an agent of a first observability platform, first observability information associated with the first observability platform;
monitoring, by the device executing the agent, for a message containing second observability information on the device generated for a second observability platform;
generating a new observability information as a combination of the first observability information and the second observability information; and
providing the new observability information to a given observability backend service within a computer network via an observability pipeline associated with the given observability backend service.
